(19) United States
(12) Patent Application Publication
(10) Pub. No.: US 2007/0041038 A1
(43) Pub. Date: Feb. 22, 2007

(54) Image forming apparatus and control method therefor

(75) Inventors: Ikuo Nishida, Yokohama-shi (JP); Aiko Okajima, Yokohama-shi (JP)

Correspondence Address: SoCAL IP LAW GROUP LLP, 310 N. WESTLAKE BLVD. STE 120, WESTLAKE VILLAGE, CA, 91362, US

(73) Assignees: Kabushiki Kaisha Toshiba, Minato-ku (JP); Toshiba Tec Kabushiki Kaisha, Shinagawa-ku (JP)

(21) Appl. No.: 11/207,466

(22) Filed: Aug. 19, 2005

(51) Int. Cl. G06F 3/12

(52) U.S. Cl. 358/1.15; 358/1.13

(57) ABSTRACT

An image development unit of an MFP executes an interpretation process for a rendering command of data that is received by a data receiving unit. If a result of the interpretation process shows that the received data is print data, the image development unit executes a rendering process using a parameter for a printer, which corresponds to characteristics of the MFP, and effects printing on paper in a printer unit. If the result of the interpretation process shows that the received data is PC-FAX data, the image development unit executes a rendering process using a parameter for PC-FAX, which does not depend on the characteristics of the MFP, and further subjects the data, which is obtained by the rendering process, to a conversion process such as a resolution conversion process, thereby converting the data to a facsimile image. The facsimile image is facsimile-transmitted via an interface unit to a public line.

### BACKGROUND OF THE INVENTION

1. Field of the Invention

The present invention relates to an image forming apparatus that is capable of receiving data from a personal computer, which is connected to the image forming apparatus, and executing facsimile transmission or image formation, and to a control method therefor.

2. Description of the Related Art

In the prior art, in a state in which a personal computer (PC) is connected to a digital multi-function peripheral (MFP) over a LAN, a printer driver (including PC-Fax) is installed on the PC side, a document that is prepared on the PC is sent to the MFP, and the MFP processes the sent document and executes print-out or facsimile transmission, or stores the processed document as image data (Box function).

In the above case, however, the following problems will arise.

In the prior art, in usual cases, the data that is sent from the PC is subjected to a uniform image development process in consideration of printing characteristics of the MFP. Thus, when the data is output from the MFP as a print, an optimized image is output. However, in the case where the same data for printing is used and the data is facsimile-transmitted as PC-Fax and printed at the destination of transmission, there arises such a problem that the data does not match with the printing characteristics at the destination of transmission, and an expected image cannot be printed.

Moreover, in the case where there are a plurality of MFPs that have different printing characteristics, even a document that is prepared by the same PC may be subjected to different image development processes, depending on the MFP (origin of transmission) that executes processing. Consequently, even if the facsimile that receives the data is the same, a difference in image may occur depending on the origin of transmission.

### BRIEF SUMMARY OF THE INVENTION

The object of an aspect of the present invention is to provide an image forming apparatus, which can receive data from a personal computer that is connected to the image forming apparatus and execute an optimized image development process in accordance with processing of the received data, and a control method therefor.

According to an aspect of the present invention, there is provided an image forming apparatus that receives data from a personal computer, and executes facsimile transmission or image formation, comprising: interpretation means for interpreting, when receiving data from the personal computer, a rendering command of the received data; first control means for executing, when an interpretation result of the interpretation means shows that the received data is data for image formation, a control to execute a rendering process using a first parameter and to form an image; and second control means for executing, when the interpretation result of the interpretation means shows that the received data is data for facsimile transmission, a control to execute a rendering process using a second parameter, which is different from the first parameter, and to execute facsimile transmission.

According to another aspect of the present invention, there is provided a control method for an image forming apparatus that receives data from a personal computer, and executes facsimile transmission or image formation, comprising: interpreting, when receiving data from the personal computer, a rendering command of the received data; executing, when an interpretation result shows that the received data is data for image formation, a control to execute a rendering process using a first parameter and to form an image; and executing, when the interpretation result shows that the received data is data for facsimile transmission, a control to execute a rendering process using a second parameter, which is different from the first parameter, and to execute facsimile transmission.

Additional objects and advantages of an aspect of the invention will be set forth in the description which follows, and in part will be obvious from the description, or may be learned by practice of the invention. The objects and advantages of an aspect of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate preferred embodiments of the invention, and together with the general description given above and the detailed description of the embodiments given below, serve to explain the principles of an aspect of the invention.

FIG. 1 is a block diagram that schematically shows the structure of a digital multi-function peripheral (MFP) according to an image forming apparatus of the present invention;

FIG. 2 is a view for explaining the flow of an image development process; and

FIG. 3 is a flow chart for explaining an image development process of data that is transmitted from a PC.

### DETAILED DESCRIPTION OF THE INVENTION

An embodiment of the present invention will now be described with reference to the accompanying drawings.

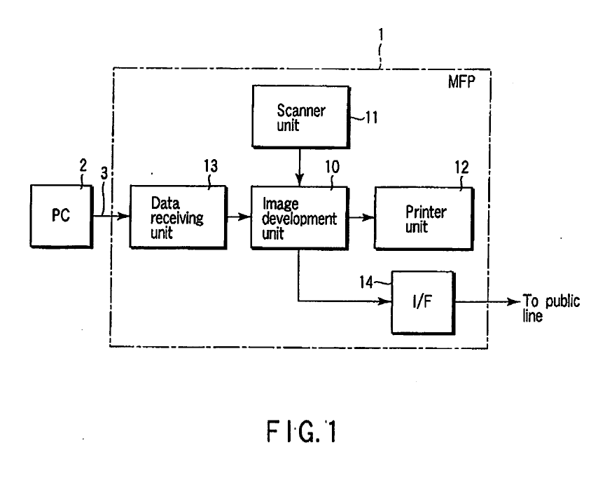

FIG. 1 schematically shows the structure of a digital multi-function peripheral (MFP) according to an image forming apparatus of the present invention. The digital multi-function peripheral (MFP) 1 is connected to a personal computer (PC) 2 over a LAN 3.

The digital multi-function peripheral (MFP) 1 comprises an image development unit 10 that executes image development process together with a control unit that executes an overall control; a scanner unit 11 that reads an image on an original; a printer unit 12 that forms an image on paper on the basis of image data; a data receiving unit 13 that receives data from the PC 2; and an interface 14 that sends facsimile data from the image development unit 10 to a public line.

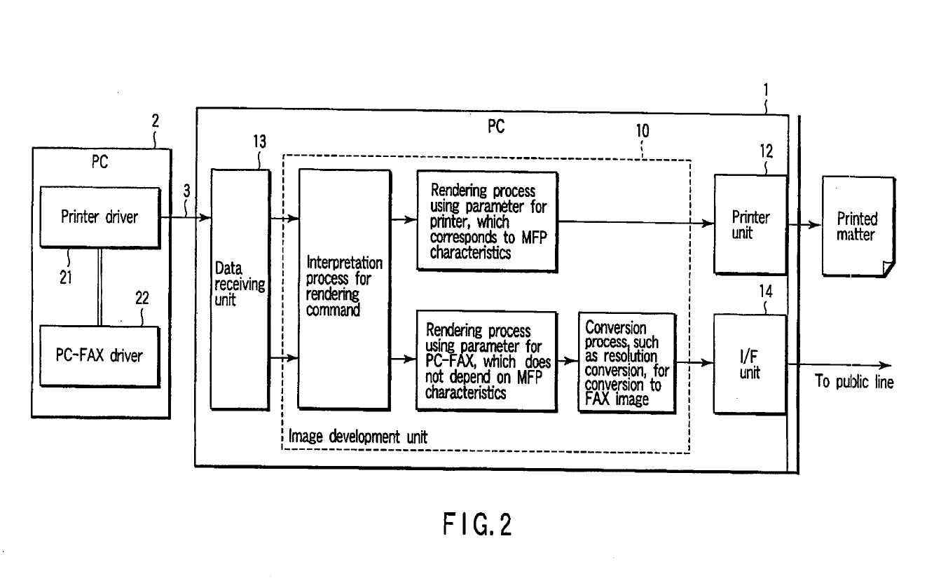

FIG. 2 is a view for explaining the image development process.

Data (print data) that is generated by a printer driver 21 of the PC 2 is received by the data receiving unit 13 of the MFP 1 via the LAN 3.

The image development unit 10 executes an interpretation process for a rendering command in the received data. As mentioned above, in the case of print data, the print data is subjected to a rendering process using a parameter for a printer, which corresponds to the characteristics of the MFP 1, and the print data is printed out on paper as a printed matter in the printer unit 12.

On the other hand, data (PC-FAX data: facsimile data) that is generated by a PC-FAX driver 22 of the PC 2 is received by the data receiving unit 13 of the MFP 1 via the LAN 3.

The image development unit 10 executes an interpretation process for a rendering command in the received data. As mentioned above, in the case of PC-FAX data, the PC-FAX data is subjected to a rendering process using a parameter for PC-FAX, which does not depend on the characteristics of the MFP 1. The PC-FAX data is converted to a facsimile (FAX) image by a conversion process such as a resolution conversion process, and the facsimile (FAX) image is facsimile-transmitted to the public line via the interface (I/F) 14.

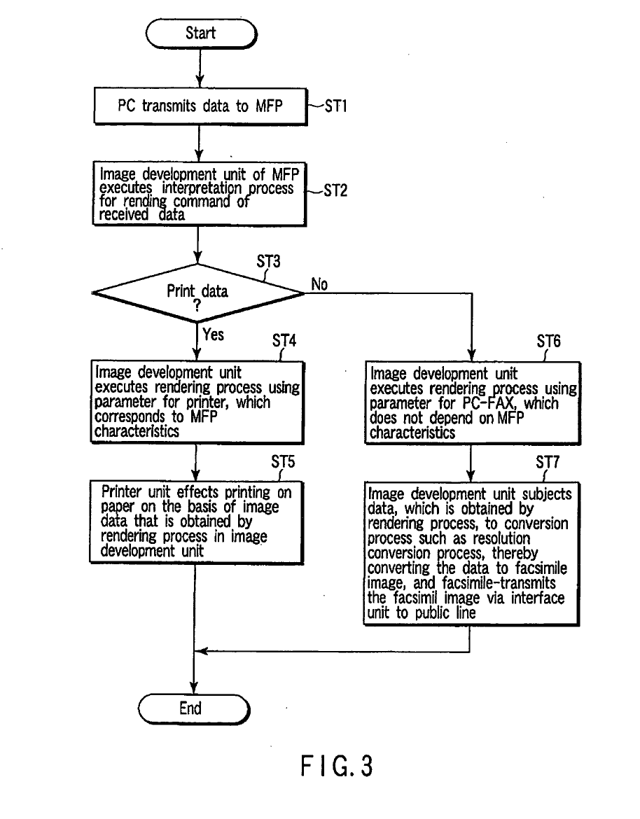

Referring now to a flow chart of FIG. 3, a description is given of the image development process for the data that is transmitted from the PC in the above-described structure.

To start with, in the case of print-out, the PC 2 sends data to the MFP 1 via the LAN 3 using the printer driver 21 (ST1). In the case of facsimile transmission, the PC 2 transmits data to the MFP 1 via the LAN 3 using the PC-FAX driver (ST1).

The image development unit 10 of the MFP 1 executes an interpretation process for a rendering command in the data received by the data receiving unit 13 (ST2).

If the result of the interpretation process shows that the received data is print data (ST3), the image development unit 10 executes the rendering process using a parameter for the printer, which corresponds to the characteristics of the MFP 1 (ST4).

Subsequently, the printer unit 12 executes printing on paper on the basis of image data that is obtained by the rendering process in the image development unit 10, and produces a printed matter (ST5).

In step ST3, if the result of the interpretation process shows that the received data is PC-FAX data, the image development unit 10 executes the rendering process using a parameter for PC-FAX, which does not depend on the characteristics of the MFP 1 (ST6). Further, the image development unit 10 subjects the data, which is obtained by the rendering process, to a conversion process such as a resolution conversion process, thereby converting the data to a facsimile image. The facsimile image is facsimile-transmitted to the public line via the interface unit 14 (ST7).

The above-described parameters may not correspond to the MFP characteristics, and a plurality of parameters, as indicated in items 1-4 below, for instance, may be prepared. An optimal parameter may be selected in accordance with the interpretation process.

1. A threshold value for binarizing multi-value data (generally called “screen” or “half-tone table”)

2. A gamma table (density curve).

3. A threshold value of “Thin Line Limit” (for instance, a value of “2 dots” in a case where a thin line of 2 dots or less is treated as a 2-dot line).

4. A parameter for color conversion (parameter that is used in a calculation formula when RGB or CMYK is converted to grey).

In the above-described embodiment, the image development unit 10 executes the process using software, but hardware may be used for the process.

In the above-described embodiment, the MFP 1 and PC 2 are connected over the LAN 3. Alternatively, a parallel cable may be used, or a USB memory that stores printer driver output data may be used.

As has been described above, according to the embodiment of the invention, the image development process is executed by selecting a parameter in accordance with the data that is sent from the PC, and thereby the optimized process can be executed.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An image forming apparatus that receives data from a personal computer, and executes facsimile transmission or image formation, comprising:
interpretation means for interpreting, when receiving data from the personal computer, a rendering command of the received data;
first control means for executing, when an interpretation result of the interpretation means shows that the received data is data for image formation, a control to execute a rendering process using a first parameter and to form an image; and
second control means for executing, when the interpretation result of the interpretation means shows that the received data is data for facsimile transmission, a control to execute a rendering process using a second parameter, which is different from the first parameter, and to execute facsimile transmission.

2. The image forming apparatus according to claim 1, wherein the first control means executes a control to form an image using image forming means on the basis of image data that is obtained by the rendering process.

3. The image forming apparatus according to claim 1, wherein the second control means subjects data, which is obtained by the rendering process, to a conversion process such as a resolution conversion process, thereby converting the data to a facsimile image, and facsimile-transmits the facsimile image via a public line.

4. The image forming apparatus according to claim 1, wherein the first parameter is a parameter that corresponds to characteristics of the image forming apparatus, and the second parameter is a parameter that has no dependency on the characteristics of the image forming apparatus.

5. The image forming apparatus according to claim 1, wherein a threshold value for binarizing multi-value data is used as the first and second parameters.

6. The image forming apparatus according to claim 1, wherein a gamma table is used as the first and second parameters.

7. The image forming apparatus according to claim 1, wherein a threshold value of Thin Line Limit is used as the first and second parameters.

8. The image forming apparatus according to claim 1, wherein a parameter for color conversion is used as the first and second parameters.

9. A control method for an image forming apparatus that receives data from a personal computer, and executes facsimile transmission or image formation, comprising:
interpreting, when receiving data from the personal computer, a rendering command of the received data;
executing, when an interpretation result shows that the received data is data for image formation, a control to execute a rendering process using a first parameter and to form an image; and
executing, when the interpretation result shows that the received data is data for facsimile transmission, a control to execute a rendering process using a second parameter, which is different from the first parameter, and to execute facsimile transmission.

10. The control method for an image forming apparatus, according to claim 9, wherein after the rendering process is executed using the second parameter, the data, which is obtained by the rendering process, is subjected to a conversion process such as a resolution conversion process, and converted to a facsimile image, and the facsimile image is facsimile-transmitted via a public line.
